(19) United States
(12) Patent Application Publication
(10) Pub. No.: US 2009/0089430 A1
(43) Pub. Date: Apr. 2, 2009

(54) Alternative fuels resource allocation system

(76) Inventor: Jamie Serra, Conyngham, PA (US)

Correspondence Address: Jamie Serra, 148 Main Street, P.O. Box 1331, Conyngham, PA, 18219-1331, US

(21) Appl. No.: 11/904,372

(22) Filed: Sep. 28, 2007

(51) Int. Cl. G06F 15/173

(52) U.S. Cl. 709/226

(57) ABSTRACT

A database information system that provides the means, method or process by which entities or individuals assess, interpret, analyze, compile and disseminate information pertaining to alternative energy production, resource development or the like.

### STATEMENT OF FEDERALLY SPONSORED RESEARCH OR DEVELOPMENT

This application is being assembled due to activities beyond the scope of federally supported research and development initiatives. There is no need to differentiate a statement of rights.

### BACKGROUND

The alternative fuel industry in the United States is at a crossroads, and the next decade will determine if this new industry will embark on a major expansion that will allow it to make significant contributions to rural economic development, improvements in urban air quality, and the energy security of our country.

The United States is one of the world's largest agricultural producers, with production facilities processing exponential volumes of agricultural resources on a daily basis. As a result, there is a sizable accumulation of waste resources, which can be used in the processing of alternative fuels. That being said, the United States is geographically located to capitalize on this newly developing industry.

With this in mind, the decision was made to incorporate the Clean and Green Fuels Fund, a non-profit, non-partisan corporation dedicated to the advancement, development, and implementation of alternative fuel technologies. This patent application covers the means by which the Clean and Green Fuels Fund will facilitate the developments aforementioned within this section.

A database information system that provides the means, method or process by which entities or individuals assess, interpret, analyze, compile and disseminate information pertaining to alternative energy production, resource development or the like.

### SUMMARY OF INVENTION

The conditions provided within the ABSTRACT of this document provide the context of the environment when such an application was derived, this section describes exactly how the application will be put to use within such an environment.

As described within the ABSTRACT, these conditions classify the alternative fuel industry as a niche system containing various components. No single industry can monopolize the development of this industry. The objective of the Alternative Fuels Resource Allocation System is to combine these contributing industries resources in order to generate superior alternative fuels.

When analyzing industries that operate on the principals highlighting the laws of capture, these corporations are inclined to exploit the resources they control for pecuniary gain. Although some resources are renewable, this doesn't mean they may be squandered. Inefficient expenditure of renewable resources will lead to their depletion, hampering efforts of producing superior alternative fuels.

The Clean and Green Fuels Fund's solution for the problems generated by this capitalistic view of improper resource use; was to create a public charity that will allow supporting components of the alternative fuel industry to prosper, through the use of the Alternative Fuel Resource Allocation System.

### Section 1. Purpose:

The purpose of the Clean and Green Fuels Fund's Alternative Fuel Resource Allocation System is to foster development in existing industries by establishing market prices for unused or overlooked resources through establishing assessments of market forces, expanding economic and rural development. There are no related applications concerning this invention. In creating a user driven Internet based database, the Clean and Green Fuels Fund has enabled residential and/or commercial locations worldwide to submit their information to the database, which pertain to particular resources capable of conversion into alternative fuels.

### Section 2. Description:

### Construction/Backend Server Scripting:

The Allocation System is scripted in PHP and mySQL programming languages. It consists of one mySQL database with 3 information tables. A “Users” table for username and password verification, a “Organization” table which registers the household name or the organizations legal name, EIN # (if applicable), address of facility(s), County, City, State, Zip, Country, e-mail address, phone number, website (if applicable), type of location (residential or commercial), as well as the longitude and latitude of such location.

The third set of information is contained in the allocation system's database “Resource” table which contains the category type of such domestic renewable resources capable of alternative fuel production, a resource description supplied by the user, the quantity of such resource(s) (mass or volume measurements, English and Metric Units), the annual output of such resource(s) (months, days or years), the waste type (residential or commercial), the organization name, address, City, State, Zip, Country, phone number, email, website (if applicable), and the longitude and latitude of such a location where such a resource is contained. Also contained within this table is a timestamp of submission.

Please note: There are multitudes of different configurations to program and organize information within a system as described within this application. This patent application covers what information will be utilized; its purpose for such organization and the end result of such organization regardless of what structure or programming language is implemented in order to produce the end results as described in the CLAIMS section of this application.

### Section 2a). Function: Back End (Server Side)

When a user registers on the database they supply the information required within the “Organization” table of the database. Upon registration a confirmation email is sent to the email address they supply on the registration form, this email contains an exact copy of the information they've registered on the database.

At the same time a user registers on the database, the username and password they specify are loaded into the “Users” table of the database. The “Users” table is linked directly to the “Organization” table so when users login to submit information to the “Resource” table, the database understands which user submitted what resource and can later query these entries.

When a user registers, their address undergoes a process known as GeoCoding. This is the process by which a physical address is turned into longitude and latitude coordinates to be plotted on a map. Upon submission the database converts the users address into latitude and longitude coordinates and stores this information in the “Organization” table of the database.

After a user is registered on the database they can submit information regarding the domestic renewable resources they produce in a given time period at a specific location. The information from the “Organization” and “Users” table is parsed into the “Resource” table allowing the information to be queried and instantly plot the relevant points of interest on an interactive map contained on the same page.

### Section 2b). Function: Front End Graphic User Interface (GUI)

The GUI users are met with is a combination of PHP, JAVA, and HTML. The included reference pictures illustrate the various sections of the database. See DRAWINGS PAGE 1 and 2.

Section 2b. I) Database Query Form

The database query form allows users to query the database. It allows anyone (including non-registered users) to search for available domestic renewable resources viable for conversion into alternative fuel.

Search selections include Resource, Country, State, Zip, Residential, Commercial or both waste types (Residential and Commercial). See FIG. 2b #I on drawings page.

Section 2b. II) Database Map Query Display

The allocation systems map display plots the points of the longitude and latitude coordinates which are provided by the information a user enters upon registration and submission information.

There are three different view types provided by the interactive map, a traditional map with transportation routes mapped out, a satellite composite image which contains geographical characteristics as well as images of buildings at street level, and a hybrid map which is a combination of the two aforementioned map styles (transportation routes, and geographical characteristics).

The map has controls for positioning the map over the desired location. The user can drag the map into position, or use the North, South, East and West controls. There is also a zoom control bar the user may click to move toward its respective direction. Aside from controls placed on the map, users may scroll with their mouse to zoom in and out, as well as double click on a particular location. See FIG. 2b #II

When a user clicks a marker placed on the database's map an information window appears on the map, which includes all the information possessed within the resource allocation database as described in section 2a of this document.

### See FIG. 2b #IIa

When a user zooms in on a specific point they are also able to view a street level composite image as described in the second paragraph of Section 2b. II “Database Map Query Display” within the specification and depicted in FIG. 2b #IIb on the Second drawing page of this document. See FIG. 2b #IIb

There are an infinite number of ways this specific database could be structured, arranged, organized and implemented, including but not limited to: the use of different programming languages, increased data entry, compiling and query algorithms, further refined query entries, as well as any other technological advancements that may further enhance the capability and functionality of this resource allocation system including the incorporation of telecommunication systems.

### Section 3. Other Uses:

The compilation of feasibility studies for the respective industries capable of using such resources as listed in the Clean and Green Fuels Fund's alternative fuels resource allocation database.

The tracking and accounting methods used for Renewable Energy Credits (RECs) “Green Tags” or any other emission trading credit conducted simultaneously with other functions the allocation database is capable of performing. This also includes information pertaining to emission credit certification procedures.

The integration of the allocation database's information with real time Global Positioning System (GPS) tracking systems to further facilitate the assessment and collection of such resources.

The calculation of travel times, distances, and routes for the various resources listed within the database of which the user is in control of. This also includes the use of real time traffic condition monitors from various information feeds in order to further enhance route planning procedures and execution times.

The ability to compile annual crop production data worldwide, as well as the means by which to inventory and query data across a series of years. This also includes the incorporation of statistical analysis algorithms to interpret and analyze data.

The assessment of available resources within a user defined range of a particular set of coordinates or addresses.

The ratio of domestic renewable resources produced that are capable of conversion into alternative fuel, including but not limited to: cities, counties, states/provinces, regions, countries and polygonal formations between specific user defined sets of coordinates.

Statistical inferences regarding the various percentages of resources that are produced by specific companies and what those resources are eventually used for.

### DESCRIPTION OF DRAWINGS

FIG. 2b #I:

This drawing depicts the controls by which users operate and query the database. Described in detail under Section 2b. (I) entitled, “Database Query Form” on page Five of this document.

FIG. 2b #II:

This drawing depicts the results of querying the database in which the locations of such resources are plotted on a map. The view in FIG. 2b #II is further described in detail under Section 2b. (II) entitled, “Database Map Query Display”.

FIG. 2b #IIa:

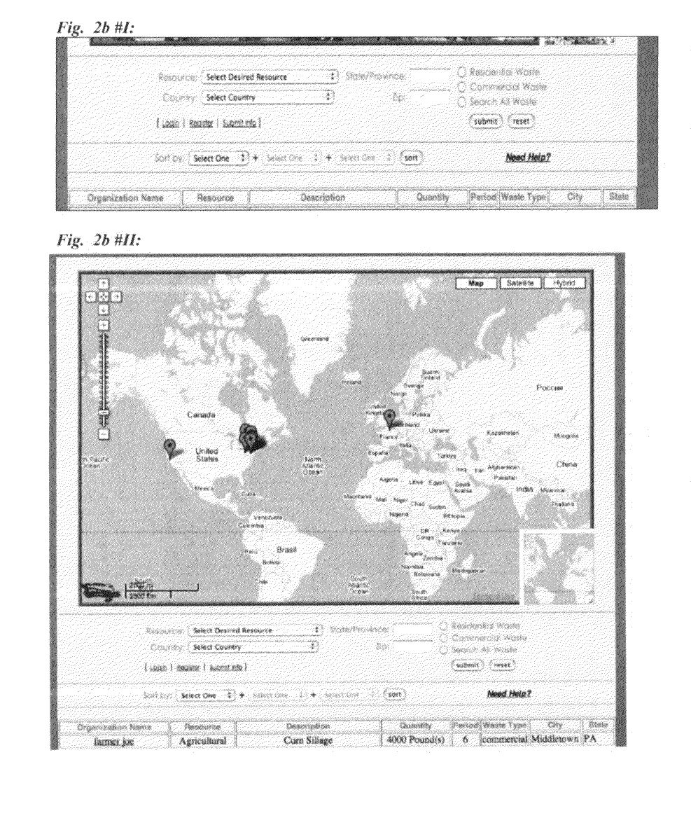

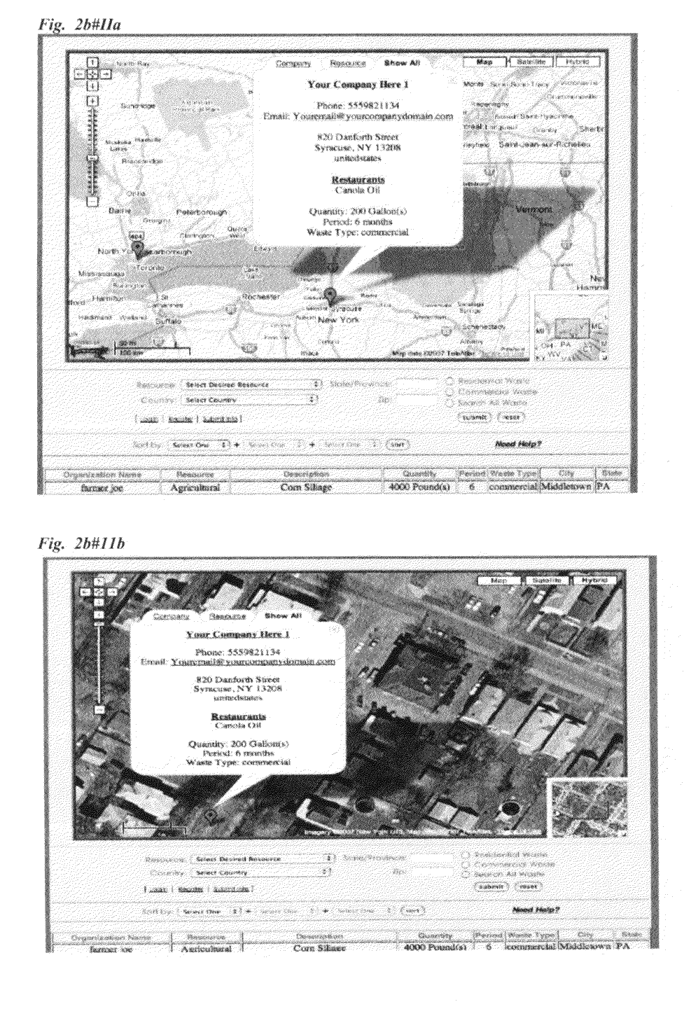

This drawing depicts the result of a user clicking on a desired location as described in Section 2b. (II) entitled, “Database Map Query Display”. FIG. 2b #IIb:

This drawing depicts the street level view as a result of a user zooming in on a specific location plotted within the database system. This drawing is further described in Section 2b. (II) entitled, “Database Map Query Display”.

1. A database system or application which contains an individuals name, the organizations legal or fictitious name(s), Employer Identification Number (EIN) (if applicable), address of facility(s) or point of origin, voter registration number, Municipality, Precinct, Ward, Legislative District(s), County, City, State, Zip, Country, e-mail address(s), phone number(s), website(s) (if applicable), type of location (residential, commercial, industrial (heavy and (or) light industry)), the category type of such domestic renewable resources capable of alternative fuel production, a resource description supplied by the user, the quantity of such resource(s) (mass or volume measurements, English and Metric Units), the annual output of such resource(s) (months, days or years), the entry date and time of such submission, as well as the longitude and latitude of such location(s).

2. A database system as described in claim 1 that provides the method, means or process by which individuals, organizations and or legal entities, States or Nations assess or generate logistical information, feasibility studies or the like, which pertain to alternative fuel resource development, including but not limited to, agricultural crop production or renewable resource production by municipal region, county, city, state, national region, hemispherical region, or global assessments thereof.

3. A database system as described in claim 1 that provides the method or means by which alternative fuel producers acquire resource information, or resources that constitute their factor(s) of production.

4. A database system as described in claim 1 that provides the method, means or process by which governmental entities assess or evaluate various regional or global alternative fuel production capabilities.

5. A database system as described in claim 1 that provides the method, means or process by which resources are allocated with the greatest degree of efficiency as pertaining to energy production.

6. A database system as described in claim 1 that provides the method, means or process by which data pertaining to alternative energy production, distribution and (or) implementation of information is collected and analyzed.

7. A database system as recited in claim 1, facilitating the compilation of feasibility studies for the respective industries capable of using such resource's information as listed in the Clean and Green Fuels Fund's alternative fuels resource allocation database.

8. A database system as recited in claim 1, facilitating the tracking and accounting methods used for Renewable Energy Credits (RECs) “Green Tags” or any other emission trading credit conducted simultaneously with other functions the allocation database is capable of performing. This also includes information pertaining to emission credit certification procedures.

9. A database system as recited in claim 1, providing the integration of the allocation database's information with real time Global Positioning System (GPS) tracking systems to further facilitate the assessment and collection of such resources as described in claim 1.

10. A database system as recited in claim 1, providing the calculation of travel times, distances and routes for the various resources listed within the database of which the user is in control of. This also includes the use of real time traffic condition monitors from various information feeds in order to further enhance route planning procedures and execution times.

11. Any and all information contained or entered within the Alternative Fuels Resource Allocation System, as described in claim 1, shall be the sole property of the applicant, Jamie Serra.

12. A database system as recited in claim 1, providing the ability to compile annual crop production data worldwide, as well as the means by which to inventory and query data across a series of years. This also includes the incorporation of statistical analysis algorithms to interpret and analyze data, including but not limited to geological, meteorological and topographical information.

13. A database system as recited in claim 1, providing for the assessment of available resources within a user defined range of a particular set of coordinates or addresses.

14. A database system as recited in claim 1, enabling the compilation of the ratio of domestic renewable resources produced that are capable of conversion into alternative fuel and those which are actually used to produce alternative fuel, including but not limited to: cities, counties, states/provinces, regions, countries and polygonal formations between specific user defined sets of coordinates.

15. A database system as recited in claim 1, providing for Statistical descriptions and inferences regarding the various percentages of resources that are produced by specific entities and what those resources are eventually used for.

16. A database system as described in claim 1, which integrates the usage of a planimeter in order to refine data, generate statistical analyses, feasibility studies or compilations of logistical information that aids the process of interpreting, disseminating, and utilizing information via refined query results.

17. A database system as described in claim 1, which integrates the use of, or relies solely upon contemporary or future telecommunication technologies, Geographic Information Systems (GIS) or Global Positioning Systems (GPS).
